(19) United States
(12) Patent Application Publication
(10) Pub. No.: US 2009/0079829 A1
(43) Pub. Date: Mar. 26, 2009

(54) Multi-functional side rear view mirror for vehicles

(75) Inventor: Tianyi Hu, Toronto (CA)

Correspondence Address: Tianyi (Albert) Hu, Apt. 207, 120 Broadway Ave, Toronto, ON, M4P 1V6, CA

(73) Assignee: Tianyi Hu, Toronto (CA)

(21) Appl. No.: 12/209,196

(22) Filed: Sep. 11, 2008

Related U.S. Application Data
(60) Provisional application No. 60/994,997, filed on Sep. 25, 2007.

(51) Int. Cl. H04N 7/18

(52) U.S. Cl. 348/148; 348/E07.085

(57) ABSTRACT

A side rearview mirror with one-way mirror, video display monitor and camera for the driver to easily and safely view the traffic that is going straight from the other direction at an intersection while trying to make a left turn, while at the same time not losing the function of a regular rearview mirror. The camera is facing the front and the video monitor is immediate placed behind the one way mirror to achieve said functions.

### CROSS-REFERENCE TO RELATED APPLICATIONS

This application claims the benefits of USPTO provisional utility application No. 60/994,997 filed on Sep. 25, 2007. The content of which is hereby incorporated into this application.

### STATEMENT REGARDING FEDERALLY SPONSORED RESEARCH OR DEVELOPMENT

Not applicable

### REFERENCE TO A SEQUENCE LISTING, A TABLE OR A COMPUTER PROGRAM LISTING COMPACT DISK APPENDIX

Not applicable

### BACKGROUND OF THE INVENTION

On most major roads in the world, cars (Car A) making a left turn must wait for cars that are going straight from the opposite direction when the green light is on. If there was a Car B waiting to make a left turn from the other side of the intersection on the other direction too, the Car A driver's sight will be blocked by Car B, as shown in FIG. 1. In this situation, cars running straight behind Car B cannot be seen by the driver of Car A. If the left-turn is made without being aware of vehicles going straight behind Car B, an accident may be caused and the traffic may be delayed. The same concept applies to countries where cars run on the right half of the road too.

In a British Colombia alone, Left-turn across oncoming traffic accidents account for 14.97% of all accidents hurting thousands of people each year. (Table 9.04, Traffic Collision Statistics 2004, from http://www.icbc.com/library/research_papers/trafficc/pdf/Traffic_Collision_Statistics_{—}2004.pdf)

My invention will help the driver see vehicles behind Car B easily without having to stick the driver's head out unsafely.

### BRIEF SUMMARY OF THE INVENTION

This invention allows the driver of a typical vehicle to have a broader view of the road by presenting a vehicular left side rear view mirror that has at least one camera installed on. The lens of the camera is facing the direction of the front of the vehicle, so that more images behind above-mentioned Car B can be captured without having the driver to stick his/her head out of the window. The images captured by the camera will be displayed on the glass mirror of the same rear view mirror unit, implemented by inserting a displaying screen, for example a Liquid Crystal Display monitor, behind the mirror and substituting the common mirror to a one-way mirror. In this manner, lights emitted by the displaying screen will be able to pass through the one-way mirror when the screen is turned on. When the displaying screen is turned off the one-way mirror can be used as normal rearview mirror. This invention enables the driver to have a “third eye”, the camera, to observe where cannot be seen easily, thus avoid traffic accidents.

### BRIEF DESCRIPTION OF THE DRAWING

The figures of the drawing are briefly described as follows:

FIG. 1 is Car A's driver's view, with Car B blocking the sight of cars behind it.

FIG. 2 is the cross section of the rear view mirror unit.

FIG. 3 is the cross section of the rear view mirror unit with the one-way mirror rotated to about 80 degrees.

FIG. 4 is an application of this invention without the mirror rotating axis, which also satisfy the purpose of this invention.

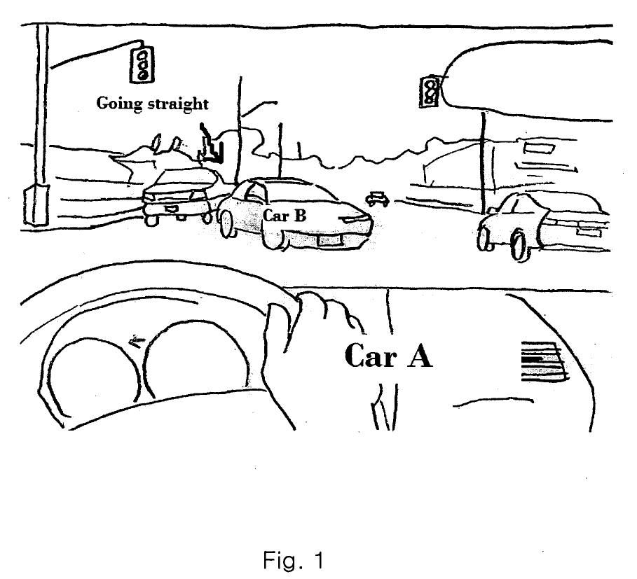

### LIST OF REFERENCE NUMERALS UTILIZED IN THE DRAWING

1—a casing unit.

2—one-way mirror.

3—high brightness video display monitor.

4—direction adjusting device for the one-way mirror and/or the lens of the camera.

5—transparent board of the casing unit

6—lens of the camera

7—camera in the front of the rear view mirror system (within the case)

8—fixed supporting board

9—Rotating axis of the one-way mirror

### DETAILED DESCRIPTION OF THE INVENTION

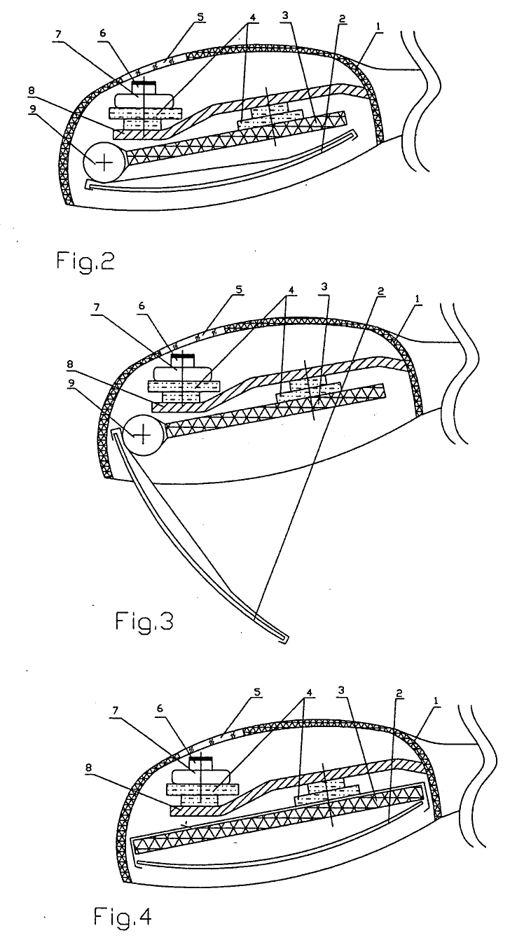

This invention has a digital camera installed within the case of the rear view mirror system, and the position of the camera is close to the tip of the casing unit, which is the best place to observe the cars that are going straight from the other direction behind Car B. A hole is made on the casing unit where the camera is, and covered by a piece of transparent protective board so the lens of the camera is exposed to light. The fixed supporting board separates the whole rear view system into two portions, one in the front and one in the back. The direction adjusting device for the camera (which is the same as the direction adjusting device for the one-way mirror ) is installed on the front side of the fixed supporting board(as shown in FIG. 2), the direction adjusting device for the one-way mirror is installed on the other side of the fixed supporting board. These adjusting devices are commonly found in existing side rear view mirrors. There is also one video display monitor installed between the one-way mirror and its adjusting device, and the one-way mirror is directly connected with the video display monitor by a mirror rotating axis. Therefore the direction of the one-way mirror can be adjusted by the direction adjusting device for the one way mirror, it can also be opened by the rotating axis. The video display monitor behind the one-way mirror is used to display images captured by the camera in the front, there is also video input and power input to the video display monitor. The driver can let other screen(s) display the image captured by the camera or let the video display monitor in the rear view mirror system display other video signals (it can be connected with cameras at other locations).

The one-way mirror is a kind of glass or any other transparent plate with the best ratio of light being reflected and light passed through the glass. It is usually manufactured by plating or sticking a thin layer of silver or aluminum on to the glass and the layer is so thin that not all lights are being reflected. “one-way mirror” is also called “two-way mirror”. The trait of one-way mirror is that if you look at the one-way mirror from the brighter side of the one-way mirror, it looks exactly like a mirror, if you look at it from the darker side of the one-way mirror, it looks like a transparent glass. When the video display monitor is turned off or inactivated, the one-way mirror will act like a regular mirror because there is no light inside the rear view mirror system, making the outside much brighter. When the car is making a left turn and the video display monitor is turned on or activated to observe the cars that are going straight, the driver can see the images displayed by the monitor clearly through the one-way mirror (the one-way mirror act like transparent) because the monitor is much brighter than the environment outside. In some special cases, the sunlight, or the light from cars in the back, after being reflected by the one-way mirror, will going into the driver's eyes directly, therefore the environment outside will be brighter than inside so the driver can not see the video display monitor clearly. In these situations, drivers can rotate the one-way mirror to an angle which allows the video display monitor to be in the sight of the driver, as shown in FIG. 3, the mirror rotator is fixed on the video display monitor, it can be turned by a small motor or an electromagnet. The rotator will turn the one-way mirror to the ideal angle. At the same time, the one-way mirror will block the light that is coming from the back, therefore the driver can see the video displaying monitor clearly. The light blocking objects can be added to the upper and lower surfaces of the rear view mirror's case but it is not a must.

There are controllers for video display monitor and the mirror rotator, and controllers for the direction adjusting devices for the mirror and the camera inside the car where the driver can reach. The camera, the video display monitor and all the direction adjusting devices use the battery of the car and there are wires transmitting the electricity from the car to all components inside the rear view mirror system that need electricity.

There are 3 practical applications for this invention:

Application 1: As shown in FIG. 2, the mirror is connected with the video display monitor by a mirror rotator. The mirror is one-way mirror, when the environment outside is not too bright, the mirror rotator will not turn the one-way mirror after the video display monitor is turned on, it will keep the position shown in FIG. 2, and the driver can see the video display monitor clearly. When the environment outside of the rear view mirror system is relatively brighter, it will not be easy to see the video display monitor through the one-way mirror, at this point, the driver can use the controlling system inside the car to turn the one-way mirror by turning on the mirror rotator, as shown in FIG. 3, the video display monitor will be exposed to the driver's sight and the one-way mirror will block the lights at the same time, therefore the driver can see the video display monitor even more clearly.

Application 2: As shown in FIG. 2, the mirror is connected with the video display monitor, the mirror here in this practical example is a regular mirror (does not allow any light to go through). When the video display monitor is turned on, the mirror rotator will rotate the mirror at the same time, turning the mirror into an angle which allows the driver to see video display monitor, as shown in FIG. 3. At the same time, the mirror can block the light, therefore the driver can see the monitor clearly.

Application 3: As shown in FIG. 4, the video display monitor is connect directly with the one-way mirror, and no mirror rotator is needed. When the video display monitor is not working, the one-way mirror looks like the regular mirror. As soon as the driver turns on the video display monitor, the driver will be able to see the monitor clearly through the one-way mirror because the monitor is much lighter than the environment outside, the screen is preferred to be high brightness outdoor LCD monitor, especially for this specific example. Application 2 and 3 are simplified versions of Application 1.

1. A side rearview mirror for a vehicle comprising:
At least one video camera facing the direction of the front of the vehicle
A one way mirror or a mirror on the said rear view mirror facing the direction of the back of the vehicle instead of a regular mirror commonly found on the streets.
A video display monitor placed inside the case of said rearview mirror immediately behind the one way mirror facing the same direction as the one way mirror.

2. The rearview mirror for a vehicle of claim 1 wherein the lens portion of the case of the rear view mirror has a hole through which said lens of said video camera faces.

3. The rearview mirror of claim 1 wherein the lens portion of the case of the rearview mirror has a generally transparent window covering the hole through which said lens of said video camera faces.

4. Said video display monitor and the one way mirror are connected with a mirror rotating device which can open the mirror to an ideal and adjustable degree equals to or less than 90 degrees to expose the video display monitor to the driver's sight and is powered by the electricity of the car.

5. The said video camera and the video display monitor, which is directly connected with the mirror or one-way mirror, are installed on a position and direction adjusting device that are commonly found in existing rearview mirrors.
